(19) United States
(12) Patent Application Publication
(10) Pub. No.: US 2010/0194291 A1
(43) Pub. Date: Aug. 5, 2010

(54) ILLUMINATION APPARATUS

(75) Inventor: Tomoko Ishiwata, Kanagawa (JP)

Correspondence Address: DLA PIPER LLP US, P. O. BOX 2758, RESTON, VA, 20195, US

(73) Assignee: TOSHIBA LIGHTING & TECHNOLOGY CORPORATION, Yokosuka-shi (JP)

(21) Appl. No.: 12/679,913

(22) PCT Filed: Aug. 8, 2008
(86) PCT No.: PCT/JP2008/064310

§ 371 Date: Mar. 25, 2010

(30) Foreign Application Priority Data
Sep. 26, 2007 (JP) 2007-249993
Nov. 29, 2007 (JP) 2007-309269

(51) Int. Cl. H05B 37/02

(52) U.S. Cl. 315/153

(57) ABSTRACT

An illumination apparatus includes an image sensor 11, an arithmetic unit 12, a control unit 13, and a light source unit 14. The light source unit 14 can irradiate at least red, green, and blue lights. Thee image sensor 11 photographs an object illuminated by the light source unit. The arithmetic unit 12 calculates color components distributed on the object on the basis of a photographed image. The control, unit 13 controls color lights of the light source unit according to the color components distributed on the object calculated by the arithmetic unit.

### TECHNICAL FIELD

The present invention relates to an illumination apparatus for making colors of an object look brighter.

### BACKGROUND ART

For example, it is well known that there is an effect that foods such as fresh meat and fresh fish are brightly rendered and made to look fresh by removing yellowness of the foods. Therefore, neodymium light bulbs obtained by mixing neodymium in bulbs of incandescent lamps in order to absorb light emission energy near 580 nm (a yellow component) are already put on the market by lighting manufacturers. It is known that the effect, is equivalent in other illumination, lamps such as a fluorescent lamp.

As a method of quantitatively evaluating color rendering properties (looks of colors) of a conventional illumination lamp, there is “an evaluation method for fidelity of looks of colors”.

This is a method, of quantitatively evaluating to which degree of fidelity a target illumination lamp reproduces colors compared with reference light such as sunlight, incandescent lamp light, and the like. At present, the method is specified by JIS Z 8726 “a color rendering properties evaluation method for a light source” and represented by a numerical value of an average color rendering properties evaluation number Ra.

As a method of evaluating subjective pleasantness of color rendering, there is a color gamut area ratio (hereinafter referred to as Ga) described in a reference (a color rendering properties evaluation method other than a method by a color evaluation properties evaluation number) of JIS Z 8726. It is possible to evaluate, with the Ga, whether an object color looks bright or looks dull when an object is illuminated by a light source. When Ga is larger than 100, chroma increases and the object color looks bright. On the other hand, when Ga is smaller than 100, chroma decrease and the object color looks dull.

As a lamp described in Japanese Patent No. 3040719, an attraction index at which four test colors (red, yellow, blue, and green) look bright is defined and a lamp and an illumination instrument with which the colors look pleasant are manufactured.

However, since the neodymium light bulb and the lamp described in Japanese Patent No. 3040719 always illuminate an object with single color light, the neodymium light bulb and the lamp cannot make plural colors included in the illuminated object look bright. When the illuminated object changes, the neodymium light bulb and the lamp described in Japanese Patent No. 3040719 cannot cope with the change.

Further, for example, when an object is illuminated by single color light, if the illuminated object is a white object such as a dish, there is also a problem in that it looks as if the white object is colored and the object does not look white.

Therefore, in view of the problems, it is an object of the present invention to provide an illumination apparatus that can make plural colors included in an illuminated object look bright.

It is another object of the present invention to provide an illumination apparatus that can make, even when an illuminated object changes, plural colors corresponding to the changed object look bright.

It is still another object of the present invention to provide an illumination apparatus that can make, when an illuminated object is a white object such as a dish, the object look white.

### DISCLOSURE OF INVENTION

### Means for Solving the Problem

An illumination apparatus according to a first aspect of the present invention includes: a light source unit configured to be capable of irradiating at least red, green, and blue lights; an image, sensor configured to photograph an object illuminated by the light source unit; an arithmetic unit configured to calculate color components distributed on the object on the basis of a photographed image; and a control unit configured to control color lights of the light source unit according to the color components distributed on the object calculated by the arithmetic unit.

In the above explanation, the light source unit may be configured by, for example, an illumination apparatus including a three-color LED configured to irradiate three color lights of red, green, and blue lights. Alternatively, the light source unit may be an illumination apparatus including a discharge lamp applied with a fluorescent material that emits colors of the red, green, and blue lights. Further, color light illumination substantially coinciding with content of a color image may be able to be performed by irradiating white light on, for example, a transmissive color liquid crystal panel, on which the color image is shown, from an incandescent lamp or a white LED. Alternatively, the color light illumination may be able to be performed by using, as color lights, white light from the incandescent lamp or the white LED resolved into three color lights of red, green, and blue lights by a prism or the like.

The image sensor is configured by, for example, a CCD or CMOS sensor including an RGB color filter or an XYZ filter.

The arithmetic unit and the control unit are configured by a microcomputer or a microprocessor, a CPU (central processing unit) or a DSP (a digital signal processor), and the like.

According to an illumination apparatus of a second aspect of the present invention, in the illumination apparatus described in claim 1, the arithmetic, unit calculates a distribution of colors corresponding to positions of portions of the object in the photographed image, and the control unit controls the light source unit to generate the distribution of the colors corresponding to the positions on the object.

According to an illumination apparatus of a third aspect of the present invention, in the illumination apparatus according to the first aspect, the arithmetic unit detects colors of the object in the photographed image and determines a color included in the object most, and the control, unit controls the light source unit to create light of the color determined by the arithmetic unit.

According to an illumination apparatus of a fourth aspect of the present invention, in the illumination apparatus according to the first or third aspect, the image sensor includes a filter approximated to an XYZ color matching function.

According to an illumination apparatus of a fifth aspect of the present invention, in the illumination apparatus according to the first aspect, the arithmetic unit detects R, G, and B gradation values of pixels in the photographed image and calculates a light mixing ratio in the light source unit according to the gradation values, and the control unit controls the light source unit to reproduce the light mixing ratio determined by the arithmetic unit.

According to an illumination apparatus of a sixth aspect of the present invention, in the illumination apparatus according to the first or fifth aspect, the image sensor includes an RGB color filter.

An illumination of to a seventh aspect of the present invention further includes, in the illumination apparatus according to any one of the third to sixth aspects, means configured to select, in a photographed image, as a target portion, only a portion desired to be highlighted or a portion excluding a background and in that colors in a selected, range can be highlighted.

According to an illumination apparatus of an eighth aspect of the present invention, in the illumination apparatus according to any one of the first to seventh aspects, the light source unit is a projection projector.

The projection projector can perform, for example, like a liquid crystal projector, color light irradiation substantially coinciding with content of a color image by irradiating white light in a state in which the color image is shown on a transmissive color liquid crystal panel.

According to an illumination apparatus of a. ninth aspect of the present invention, in the illumination apparatus according to the fifth aspect, the arithmetic unit includes: calculating means configured to detect R, G, and B gradation values of pixels of the entire image or a part of the image photographed by the image sensor and calculate a percentage of the R, G, and B gradation values for each of the pixels; achromatic color determining means configured to determine whether each of the pixels is a chromatic color or an achromatic color on the basis of the calculated percentage of the R, G, and B gradation values for each of the pixels; and white determining means configured to distinguish between a white pixel and a gray pixel among the pixels determined as the achromatic color, and the control unit controls, when a percentage of the number of pixels determined as the white pixels is equal to or higher than a predetermined percentage with respect to the number of pixels of the entire image or a part of the image, the light source unit such that light source colors by R, G, and B mixed light are set within the range of a deviation of 0.02 from a black body radiation locus.

According to an illumination apparatus of a tenth aspect of the present invention, in the illumination apparatus according to the ninth aspect, the achromatic color determining means determines that each of the pixels is the achromatic color when all percentages of the respective R, G, and B gradation values for each of the pixels in the calculating means are equal to or higher than the predetermined percentage, the white determining means calculates an average gradation value of the R, G, and B gradation values of the pixels determined as the achromatic color in the achromatic color determining means and, when the average graduation value is equal to or higher than a predetermined gradation value or equal to or higher than a standard value set in advance, determines that the pixels are white pixels, and the control unit controls, when, a percentage of the number of pixels determined as the white pixels is equal to or higher than the predetermined percentage with respect to the number of pixels of the entire image or a part of the image, the light source unit such that light source colors by R, G, and B mixed light are set within a range of a deviation of 0.02 from a black body radiation locus.

According to an illumination apparatus of an eleventh aspect of the present invention, in the illumination apparatus according to the tenth aspect, the predetermined percentage in the achromatic color determining means is 30%, the predetermined gradation value in the white determining means is 200 (when all gradations are 0 to 255), and the predetermined percentage in the control unit is 20%.

According to an illumination apparatus of a twelfth aspect of the present invention, in the illumination apparatus according to the tenth or eleventh aspect, at least one of the predetermined percentage in the achromatic color determining means, the predetermined gradation value in the white determining means, and the predetermined percentage in the control unit can be variably set.

According to an illumination apparatus of a thirteenth aspect of the present invention, in the illumination apparatus according to the fifth aspect, the arithmetic unit includes: a first storing unit configured to store positions of the pixels in the image photographed by the image sensor and the R, G, and B gradation values of the pixels; a second storing unit configured to calculate and store positions of pixels in an image photographed next and a difference value between the R, G, and B gradation values of the pixels and the R, G, and B gradation values of the pixels at the time of the last photographing; and means configured to compare an nth (n is an integer equal to or larger than 1) difference value and an n+1th difference value and detect movement of the illuminated object, and a light modulation state at the point is maintained when there is no movement in the object according to a result of the comparison.

According to an illumination apparatus of a fourteenth aspect of the present invention, in the illumination apparatus according to the thirteenth aspect, the means configured to detect movement of the object calculates a difference between the n+1 th difference value and the nth difference value and determines the movement of the object according to whether the calculated difference is smaller than a threshold set in advance.

According to an illumination apparatus of a fifteenth aspect of the present invention, in the illumination apparatus according to the thirteenth or fourteenth aspect, the photographing of an image by the image sensor is performed every time the light mixing ratio determined by the arithmetic unit is reproduced.

According to an illumination apparatus of a sixteenth aspect of the present invention, in the illumination apparatus according to the thirteenth or fourteenth aspect, the photographing of an image by the image sensor is performed while the light mixing ratio determined by the arithmetic unit is reproduced, and every time the light mixing ratio is reproduced.

According to an illumination apparatus of a seventeenth aspect of the present invention, in the illumination apparatus according to the fifth aspect, the arithmetic unit includes: calculating means configured to calculate xy chromaticities from the R, G, and B gradation values of the pixels of the entire image or a part of the image photographed by the image sensor; and white determining means configured to distinguish, on the basis of the calculated xy chromaticity for each of the pixels, whether each of the pixels is a white pixel, and the control unit controls, when a percentage of the number of pixels determined as the white pixels is equal to or higher than a predetermined percentage with respect to the number of pixels of the entire image or a part of the image, the light source unit such that light source colors by R, G, and B mixed light are set within a range of a deviation of 0.02 from a black body radiation locus.

According to an illumination apparatus of an eighteenth aspect of the present invention, in the illumination apparatus according to the fifth aspect, the image sensor includes an XYZ filter approximated to a CIE1931 color matching function, the arithmetic unit includes: measuring means configured to measure xy chromaticities of the pixels of the entire image or a part of the image photographed by the image sensor; and white determining means configured to distinguish whether each of the pixels is a white pixel on the basis of the measured xy chromaticity for each of the pixels, and the control unit controls, when a percentage of the number of pixels determined as the white pixels is equal to or higher than a predetermined percentage with respect to the number of pixels of the entire image or a part of the image, the light source unit such that light source colors by R, G, and B mixed light are set within, a range of a deviation of 0.02 from a black body radiation locus.

According to an illumination apparatus of a nineteenth aspect of the present invention, in the illumination apparatus according to the seventeenth, or eighteenth aspect, the predetermined percentage is 20%.

According to an illumination apparatus of a twentieth aspect of the present invention, in the illumination apparatus according to the fifth aspect, the arithmetic unit includes: means configured to set an initial value of a light mixing ratio of light source colors of the light source unit; means configured to detect a change in the object over time on the basis of gradation values of the pixels of the image photographed by the image sensor; and means configured to reset the light mixing ratio to the, initial value when a change in the object is detected, and the arithmetic unit detects R, G, and B gradation values of pixels of an image photographed in a light mixing state at the initial value and calculates a light mixing ratio of the light source unit according to the gradation values.

It can be said that the light mixing ratio of the light source colors is a ratio of intensities of the R, G, and B color lights, in other words, a ratio of light modulation ratios (%) for the respective R, G, and B color lights.

According to an illumination apparatus of a twenty-first aspect of the present invention, in the illumination apparatus according to the twentieth aspect, the means configured to detect a change in the object over time calculates a difference between an n+1th (n is an integer equal to or larger than 1) difference value and an nth difference value and detects a change in the object according to whether the difference is smaller than a threshold set in advance.

With the illumination apparatus according to the first aspect, it is possible to make plural colors included in the illuminated object look bright Even when the illuminated object changes, it is possible to make plural colors corresponding to the changed object look bright. Even if the object changes, it is possible to process the object on a real time basis and make the object look bright.

With the illumination apparatus according to the second aspect, it is possible to make the plural colors included in the illuminated object look bright. Even when the illuminated object changes, it is possible to make plural colors corresponding to the changed object look bright. Even if the object changes, it is possible to process the object on a real time basis and make the object look bright.

With the illumination apparatus according to the third aspect, by making a color component included most among the plural colors included in the illuminated object look bright, it is possible to create an illumination environment in which the color is highlighted. Even if the object changes, it is possible to process the object on a real time basis and make the object look bright.

With the illumination apparatus according to the fourth aspect, by calculating xy chromaticities at plural points of the image using the image sensor attached with the XYZ filter, plotting the xy chromaticities at the points on a chromaticity diagram, and detecting a color most often plotted in a range of color names, it is possible to determine the color most often plotted as a color included most in the object.

With the illumination apparatus according to the fifth aspect, by detecting, using the image sensor, RGB gradation values of the image obtained by photographing the illuminated object and turning on red, green, and blue lights at a light mixing ratio corresponding to the RGB gradation values, it is possible to create an illumination environment in which the colors of the object are highlighted. Even if the object changes, it is possible to process the object on a real time basis and make the object look bright.

With the illumination apparatus according to the sixth aspect, by photographing the illuminated object with the image sensor attached with the RGB color filter and detecting R, G, and B gradation values of the pixels, it is possible to calculate a ratio of R, G, and B components included in the object and illuminate the object with, color lights that look bright.

With the illumination, apparatus according to the seventh aspect, it is possible to make a range desired to be more accurately highlighted look bright.

With the illumination apparatus according to the eighth aspect, it is possible to substantially directly irradiate a color image obtained by photographing the object on the object as color lights using the projection projector and make the plural colors included in the object look bright.

With the illumination apparatus according to the ninth aspect, if a percentage of the number of white pixels with respect to a total number of pixels used for processing is equal to or higher than the predetermined percentage, this represents that an area occupied by the white pixels with respect to all the processed pixels is equal to or larger than a fixed area Therefore, by controlling the light source colors to be set within a range of white necessary as white on the chromaticity diagram (the range of a deviation of 0.02 from a black radiation locus), it is possible to make a white object look white.

With the illumination apparatus according to the tenth aspect, it is possible to specify a percentage value in the achromatic color determining means, a gradation value in the white determining means, and a percentage (a control condition value) in the control unit as conditions for making white look white.

With the illumination apparatus according to the eleventh aspect, if the percentage value in the achromatic color determining means is set to 30%, the gradation value in the white determining means, is set to 200, and the percentage value in the control unit is set to 20%, it is possible to present an example of the conditions for making white look white.

With the illumination apparatus according to the twelfth aspect, by making it possible to variably set at least one value of the three values described concerning the illumination apparatus according to the tenth or eleventh aspect, it is possible to easily perform adjustment for making white look white.

With, the illumination apparatus according to the thirteenth aspect, it is possible to prevent, when the object does not change, control for making the colors of the object excessively bright.

With the illumination apparatus according to the fourteenth aspect, it, is possible to prevent, when the object does not change, control for making the colors of the object excessively bright.

With the illumination apparatus according to the fifteenth aspect, it is possible to prevent, when the object does not change, control for making the colors of the object excessively bright.

With the illumination apparatus according to the sixteenth aspect, it is possible to prevent, when the object does not change, control for making the colors of the object excessively bright. Moreover, it is possible to halve time required for the movement determination compared with that in the illumination apparatus according to the fifteenth aspect.

With the illumination apparatus according to the seventeenth aspect, the xy chromaticities of the pixels calculated from the R, G, and B. gradation values on a chromaticity diagram and points plotted in a range of white are determined as white pixels. If a percentage of the number of white pixels with respect to a total number of pixels used for processing is equal to or higher than the predetermined percentage, this represents that an area occupied by the white pixels with respect to all the processed pixels is equal to or larger than a fixed area. Therefore, by controlling the light source colors to be set within a range of white necessary as white on the chromaticity diagram (the range of a deviation of 0.02 from a black radiation locus), it is possible to make a white object look white.

With the illumination apparatus according to the eighteenth aspect, the image sensor includes the XYZ filter approximated to the CIE1931 color matching function and xy chromaticities at plural points in the image are calculated by using the image sensor attached with the XYZ filter. The xy chromaticities at the points are plotted on the chromaticity diagram and points plotted in a range of white are determined as white pixels. If a percentage of the number of white pixels with respect to a total number of pixels used for processing is equal to or higher than the predetermined percentage, this represents that an area occupied by the white pixels with respect to all the processed pixels is equal to or larger than a fixed area. Therefore, by controlling the light source colors to be set within a range of white necessary as white on the chromaticity diagram (the range of a deviation of 0.02 from a black radiation locus), it is possible to make a white object look white.

With the illumination apparatus according to the nineteenth aspect, if a percentage of the number of pixels determined as the white pixels is equal to or higher than 20% with respect to the number of pixels of the entire image or a part of the image, assuming that the object is a subject having a large area of white, by controlling the light source unit such that the light source colors by the R, G, and B mixed light are set within the range of a deviation of 0.02 from a black body radiation locus, it is possible to make a white object look white.

With the illumination apparatus according to the twentieth aspect, by always resetting, when the object changes, a light mixing state to an initial light mixing state and determining colors of the object, it is possible to cancel, for example, when a large number of red components are included in a photographed image, if a light mixing state is reset to the initial state, a state in which the red components are increased by a mixed light illumination for making red look bright and prevent control for making colors of the object look excessively bright.

With the illumination apparatus according to the twenty-first aspect, when the object does not change, it is possible to prevent control for making colors of the object excessively bright.

### BRIEF DESCRIPTION OF THE DRAWINGS

FIG. 1 is a block diagram showing an illumination apparatus according to a first embodiment of the present .invention;

FIG. 2A is a diagram showing operation steps in the first embodiment;

FIG. 2B is a diagram showing an example of a photographed object in step S1 in FIG. 2A;

FIG. 2C is a diagram showing a state in which illumination light is irradiated on the object shown in FIG. 2B in step S3 in FIG. 2A;

FIG. 3 is a diagram showing a color distribution of light source colors in an xy chromaticity diagram used in an illumination apparatus according to a second embodiment of the present invention;

FIG. 4 is a diagram showing a sample image used in the second embodiment of the present invention;

FIG. 5 is a diagram showing a chromaticity plot example of the sample image shown in FIG. 4;

FIG. 6 is a graph showing a relation between outputs of each color light source and RGB gradation values of a detected image used in an illumination apparatus according to a third embodiment of the present invention;

FIG. 7 is a diagram showing an example of grids for detecting RGB gradation values;

FIG. 8 is a partially enlarged view of a chromaticity diagram showing a range within a deviation of 0.02 from a black body radiation locus used in an illumination apparatus according to a fourth embodiment of the present invention;

FIG. 9 is a flowchart showing an image processing algorithm of an arithmetic unit and a control unit;

FIG. 10A is a diagram showing a color chip of achromatic colors;

FIG. 10B is a diagram showing a color chip of chromatic colors;

FIG. 11 is a diagram showing an example in which foods are photographed by an image sensor;

FIG. 12A is a diagram related to an example of the operation of the illumination apparatus according to the fourth embodiment of the present invention and showing R, G, and B illumination lights corresponding to R, G, and B modulated light values included in an object;

FIG. 12B is a diagram related to an example of the illumination apparatus according to the fourth embodiment of the present invention and showing R, G, and B illumination lights added with a white light component in an illumination state shown in FIG. 12A;

FIG. 13 is a flowchart for explaining the operation of an illumination apparatus according to a fifth embodiment of the present invention;

FIG. 14 is a diagram for explaining difference calculation for an image in an arithmetic unit;

FIG. 15 is a diagram for explaining an example of a difference, image as an operation example of the illumination apparatus according to the fifth embodiment of the present invention;

FIG. 16 is a graph for explaining an example of the operation of the illumination apparatus according to the fifth embodiment of the present invention in acquiring three images at two light modulating periods; and

FIG. 17 is a graph for explaining an example of the operation of an illumination apparatus according to a sixth embodiment of the present invention in acquiring three images at one light modulating period.

### BEST MODE FOR CARRYING OUT THE INVENTION

Embodiments of the present invention are explained with reference to the drawings.

### First Embodiment

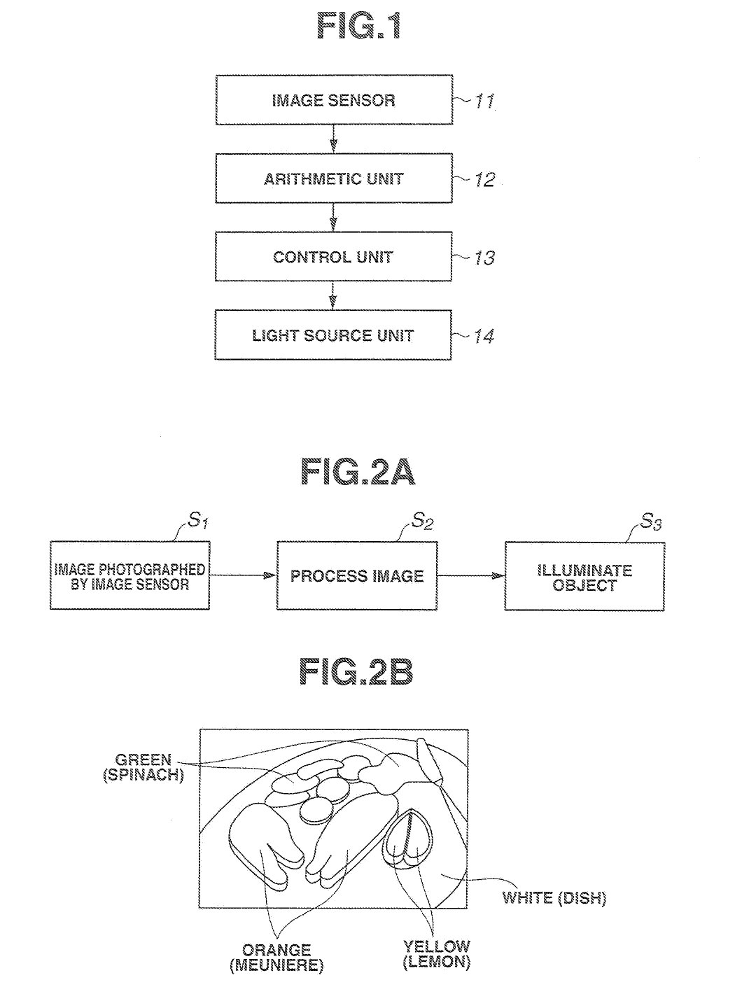

FIG. 1 is a block diagram showing an illumination apparatus according to a first embodiment of the present invention. A configuration in which blocks are arranged in operation order is shown.

The illumination apparatus according to the first embodiment shown in FIG. 1 includes: a light source unit 14 configured to be capable of irradiating at least red, green, and blue lights; an image sensor 11 configured to photograph an illuminated object; an arithmetic unit 12 configured to detect positions and colors of portions of the object in an image photographed by the image sensor 11 and calculate a distribution of colors corresponding to the positions on the object; and a control unit 13 configured to control color lights of the light source unit 14 in order to generate a distribution of colors corresponding to the positions on the object obtained by the calculation.

By configuring the illumination apparatus in this way, it is possible to realize the illumination apparatus that photographs an illuminated object with the image sensor 11, detects and calculates positions and colors of portions of the object in a photographed image, and controls the light source unit 14 such that plural colors included in the portions of the object look bright and pleasant.

For example, when it is assumed that unadjusted R, G, and B lights (e.g., not subjected to white balance adjustment) are irradiated on an object from the light source unit 14, the lights are, photographed by the image sensor 11 and colors or color components included in a photographed image are detected by the arithmetic unit 12 such that the colors or the color components included in the object shift to be bright and pleasant.

When the colors or the color components included in the object are calculated to shift to be bright and pleasant, spectra of colors and color components of a reference light source are stored in the arithmetic unit 12, the stored reference spectra are compared with spectra obtained by the R, G, and B light irradiation from the unadjusted light source unit 14, whereby a shift (a difference) of amplitudes in color wavelengths of the spectra obtained by the R, G, and B light irradiation from the unadjusted light source unit 14 is corrected and calculated to correspond to wavelength of reference colors of R, G, and B of the reference light source in the arithmetic unit 12.

A projection projector may be used as the light source unit 14. By irradiating color lights of color distribution corresponding to a color image obtained by photographing the object with the image sensor 11 on the object by using the projection projector, it is possible to accurately irradiate light matching the positions and the colors of the object and reflect the color components of the object to make the object look bright.

By using the projection projector, in principle, it is possible to project an image same as the color image of the object photographed by the image sensor with positions adjusted to correspond to respective places of the object and it is possible to make all colors in all the places of the objects look extremely bright.

When an object, in particular, a still object is photographed, as illumination light in photographing the object with the image sensor 11, light from a separate reference light source such as sunlight or an incandescent lamp is irradiated on the object to photograph the object or light with a white balance of the light source unit 14 adjusted is irradiated on the object to photograph the object. The arithmetic unit 12 detects positions and colors in portions of the object in the photographed image and calculates a distribution of colors corresponding to the positions on the object.

The control unit 13 controls, in order to generate the distribution of the colors corresponding to the positions on the object obtained by the calculation, the light source unit 14 to thereby irradiate color lights suitable for the object from the light source unit 14. If this is carried out every time the object is changed, it is possible to generate color lights matching colors or color components of an object body and irradiate the color lights on the object.

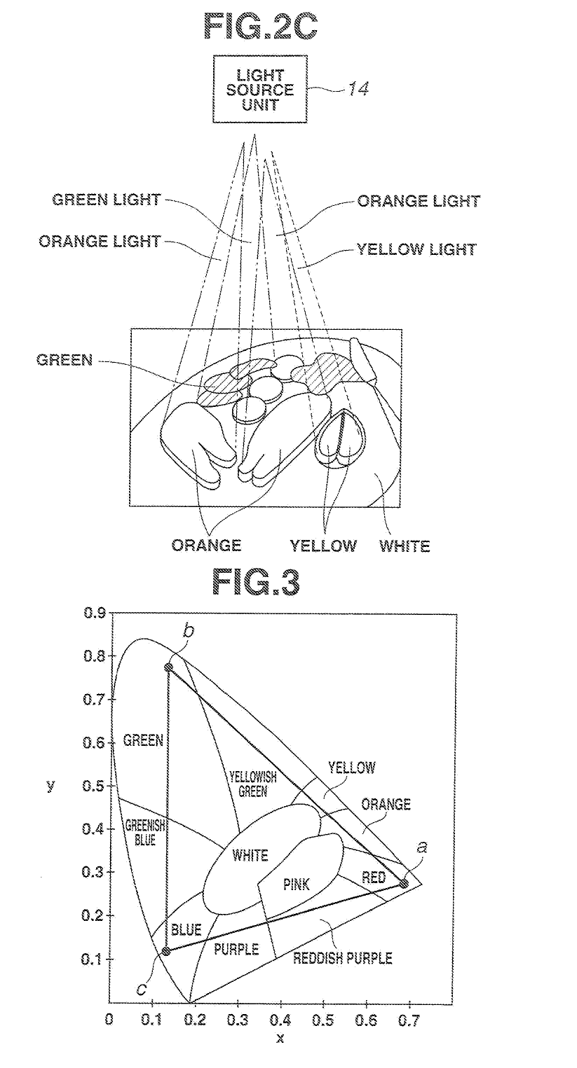

FIG. 2A is a diagram showing operation steps in FIG. 1. FIG. 2A shows three steps, i.e., step S1 for acquiring a photographed image with the image. sensor 11, step S2 for processing the image with the arithmetic unit 12 to control light colors, and step S3 for illuminating the object with the light source unit 14.

The image sensor 11 photographs an illuminated object. The arithmetic unit 12 detects colors of pixels of the image, creates light colors suitable for the object (e.g., light colors having a distribution of the same colors corresponding to positions on the object) according to the positions of the object, and irradiates light on the object.

For example, when food shown in FIG. 2B is illuminated, as shown in FIG. 2C, from the light source unit 14, light for highlighting green (green light) is irradiated on green vegetables, light for highlighting orange (orange light) is irradiated on a carrot and salmon meuniere, light for highlighting yellow (yellow light) is irradiated on a lemon, and white light is irradiated on a white dish, whereby it is possible to make all objects look bright or make the objects look delicious.

According to the present embodiment, by irradiating lights matching colors of an illuminated object on the object, it is possible to make every color of the object look bright and increase a color gamut area ratio. In other words, it is possible to make plural colors included in the illuminated object look bright. It is possible to accurately irradiate lights matching positions and colors of the object by using the projection projector. Even if the object changes, by detecting the change with the image sensor and performing processing on a real time basis, it is possible to make the object always look bright and make the object look delicious following the change.

### Second Embodiment

A block diagram of an illumination apparatus according to a second embodiment of the present invention is the same as that of FIG. 1.

The illumination apparatus according to the second embodiment includes: the light source unit 14 configured to be capable of irradiating at least red, green, and blue lights; the image sensor 11 configured to photograph an illuminated object; the arithmetic unit 12 configured to detect colors of the object in an image photographed by the image sensor 11 and determine a color included in the object most; and the control unit 13 configured to control color lights of the light source unit 14 in order to generate the color lights determined by the arithmetic unit 12.

By configuring the illumination apparatus in this way, it is possible to realize the illumination apparatus that photographs an illuminated object with the image sensor 11, detects and calculates colors of the object, detects which color component among plural colors included in the object is included by a large amount, and controls the light source unit 14 such that the color looks bright and pleasant.

The light source unit 14 includes light sources that mix lights of at least three colors of red, green, and blue and irradiate mixed light. However, light obtained by mixing red, green, and blue on the basis of a white light source may be added.

FIG. 3 shows a color distribution of light source colors in an xy chromaticity diagram.

For example, when light sources having chromaticities plotted by reference signs a, b, and c in FIG. 3 are used as light sources for red, green, and blue, colors in the inside of a triangle formed by connecting the three points a, b, and c can be created by light mixing.

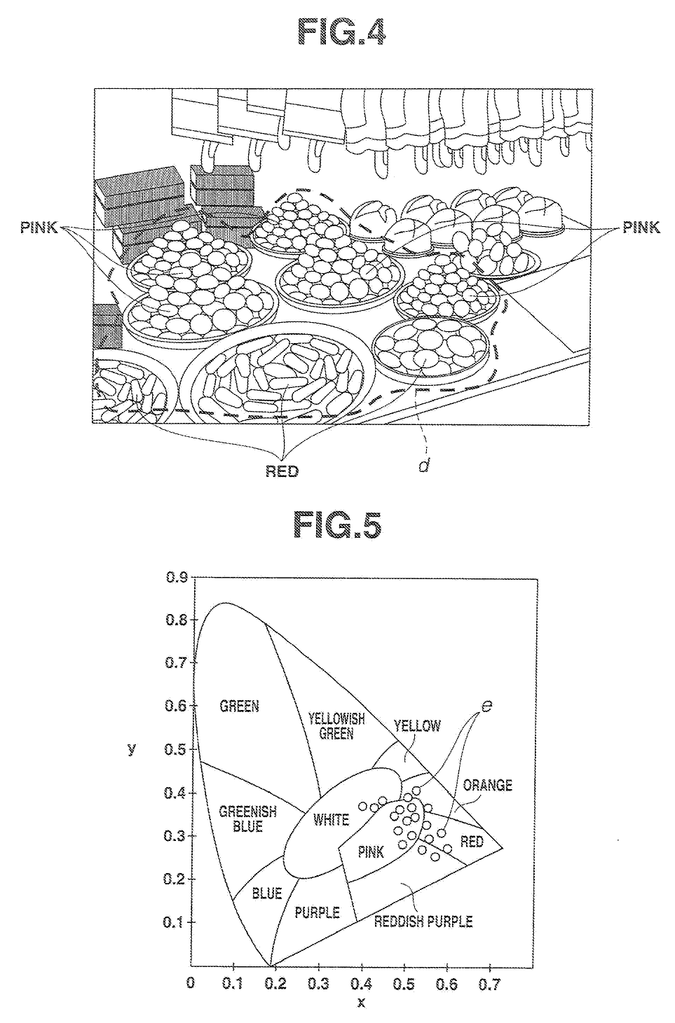

Next, a specific example in which the xy chromaticity diagram is used is explained with reference to FIGS. 4 and 5. FIG. 4 shows a sample image and FIG. 5 shows a chromaticity plot example of the sample image.

The image sensor 11 includes an XYZ filter approximated to a CIE1931 color matching function and calculates xy chromaticities at plural points in an image. The xy chromaticities at the points are plotted on the chromaticity diagram shown in FIG. 3 (as indicated by a reference sign e in FIG. 5) and a color most often plotted in a range of color names is detected. In order to highlight the most often plotted color, the light source unit 14 is controlled to create a light color included in the range of the colors according to light mixing of red, green, and blue and illuminate the object.

FIG. 5 shows a diagram on which the xy chromaticities at the plural, points are plotted (circles of the reference sign e) at equal intervals in a range of a dotted line d when it is, desired to highlight the inside of the dotted line d in a photographed image in the sample image shown in. FIG. 4.

Since a largest number of points are included in a range of pink, lights of red, green, and blue are controlled to be mixed and put in the range of pink to illuminate the object.

In the photographed image, by making a selection using an interface that can select only a portion desired to be highlighted or the object excluding a background (e.g., selecting a portion in the inside of the dotted line d in FIG. 4) and individually setting points where xy chromaticities are calculated or setting a selected range at crossing points of grids at fixed intervals, it is possible to make a color or the object desired to be more accurately highlighted look bright.

According to this embodiment, by mixing, lights matching colors of an illuminated object using the image sensor and irradiating mixed light on the object, it is possible to make the object look bright even if the object changes. By making a color component included by a large amount look bright among plural colors included in the illuminated object, it is possible to create an illumination environment in which the color is highlighted.

### Third Embodiment

A block diagram of an illumination apparatus according to a third embodiment of the present invention is the same as that of FIG. 1.

The illumination apparatus according to the third embodiment includes: the light source unit 14 configured to be capable of irradiating at least red, green, and blue lights; the image sensor 11 configured to photograph an illuminated object; the arithmetic unit 12 configured to detect R, G, and 13 gradation values of pixels in an image photographed by the image sensor 11 and calculate a light mixing ratio of the light source unit 14 according to the gradation values; and the control unit 13 configured to control color lights of the light source unit 14 in order to reproduce the light mixing ratio determined by the arithmetic unit 12.

The light source unit 14 includes a light source configured to mix lights of at least three colors of red, green, and blue and irradiate mixed light.

The image sensor 11 includes an RGB color filter.

RGB gradation values of pixels of an image photographed by the image sensor 11 are values of 0 to 255. When all of R, G, and B are 0, the image is black and, when all of R, G, and .B are 255, the image is white. If the gradation values are determined in this way, digital signal processing in 8-bit representation is possible.

By averaging, concerning the entire image, the gradation values of pixels of each of R, G, and B, percentages of R, G, and B components included in an object are calculated.

A light mixing ratio of red, green, and blue lights is determined according to the percentages of the R, G, and B gradation values.

By configuring the illumination apparatus in this way, it is possible to realize the illumination apparatus that calculates, by photographing an illuminated object with the image sensor 11 and detecting RGB gradation values of pixels, a ratio of RGB components included in the object and controls the light source unit 14 such that the object looks bright and pleasant.

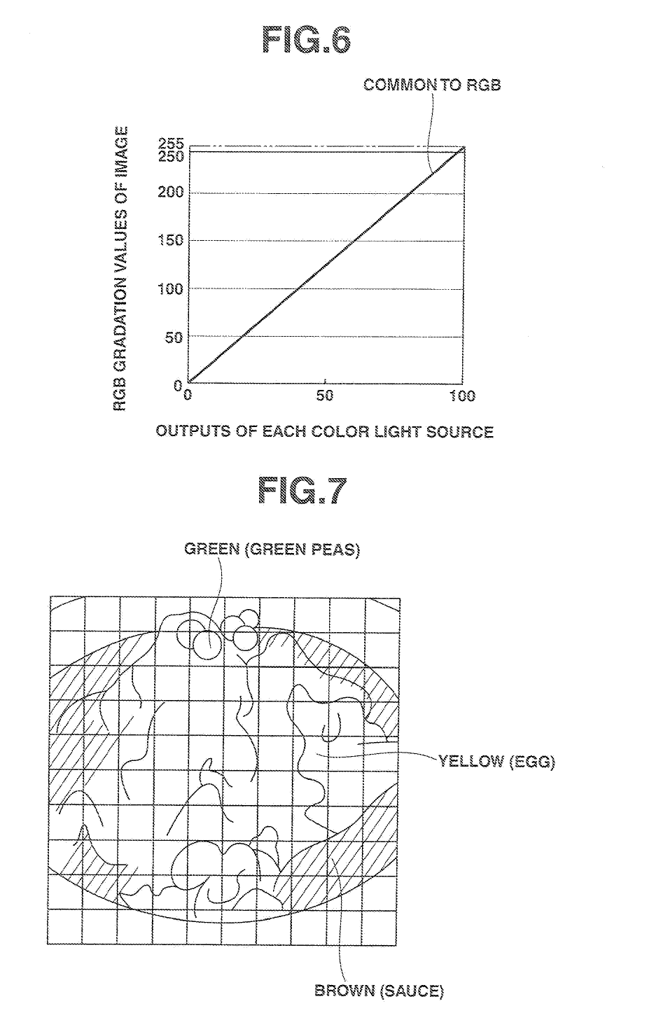

FIG. 6 is a graph showing a relation between outputs of each color light source and KGB gradation values of a detected image. FIG. 7 shows an example of grids for detecting RGB gradation values.

In FIG. 6, as a relation between ROB gradation values and outputs of each of red, green, and blue lights, the red, green, and blue lights are mixed to create white light, an output of color lights that changes to brightest white is set to 100 and light-off is set to 0, and 0 to 100 are allocated to gradation values 0 to 255.

Since detection and calculation of RGB gradation values of all pixels of an image take time, it is also possible to carry out a method of reducing processing time by dividing the image into grids as appropriate as shown in FIG. 7 and detecting gradation values in pixels at crossing points of the grids.

The tight source unit 14 may add red, green, and blue lights at a light mixing ratio corresponding to the RGB gradation values of the image on the basis of white light.

It is also possible to select, in a photographed image, only a portion desired to be highlighted or an object excluding a background using an interface that can select only the portion or the object, detects RGB gradation values in a selected range, and control light sources to have a light mixing ratio for highlighting colors in the selected range.

According to this embodiment, by detecting RGB gradation values of an image obtained by photographing an illuminated object using the image sensor and turning on red, green, and blue lights at a light mixing ratio corresponding: to the RGB gradation values, it is possible to create an illumination environment in which colors of the object are highlighted. Even if the object changes, it is possible to process the object on a real time basis to make the object look bright.

### Fourth Embodiment

A block diagram of an illumination apparatus according to a fourth embodiment of the present invention is the same as that of FIG. 1.

The illumination apparatus according to the fourth embodiment includes: the light source unit 14 configured to be capable of irradiating at least red, green, and blue lights; the image sensor 11 configured to photograph an illuminated object; the arithmetic unit 12 including calculating means configured to detect R, G, and B gradation values of pixels of the entire image or a part of the image photographed by the image sensor 11 and calculate a percentage of the R, G, and B gradation values for each of the pixels, achromatic color determining means configured to determine whether each of the pixels is a chromatic color or an achromatic color on the basis of the calculated percentage of the R, G, and B gradation values of each of the pixels, and white determining means configured to distinguish between white pixels and gray pixels among pixels determined as the, achromatic color; and the control unit 13 configured to control, when a percentage of the number of pixels determined as the white pixels is equal to or higher than a predetermined percentage with respect to the number of pixels of the entire image or a part of the image, the light source unit 14 such that light source colors by R, G, and B mixed light are set within a range of a deviation of 0.02 from a black body radiation locus.

In this embodiment, the arithmetic unit calculates a percentage of white in an object, on which light is irradiated, on the basis of a photographed image. When the percentage of white is equal to or higher than a fixed percentage, the control unit performs light modulation such that light source colors mixed such that a white object looks white are set within a range in which the light source colors are recognized as white (specifically, a range of a deviation of 0.02 from a black body radiation locus).

This is on the basis of the description “can be represented as correlated color temperature with respect to a chromaticity coordinate of, a light source present at a deviation within about 0.02 from a black body radiation locus on a CIE1960UCS chromaticity diagram” in JIS Z 8725. This means that a light source having a deviation within 0.02 can be regarded as white light.

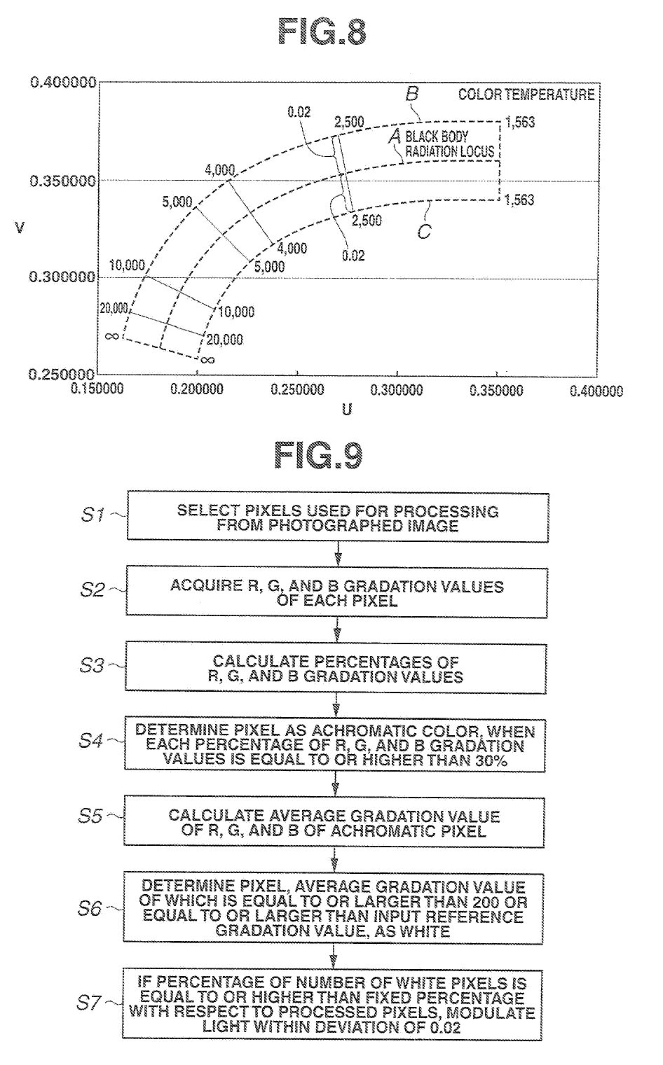

FIG. 8 is a partial enlarged view of the CM1960USC chromaticity diagram and represents a range of a deviation of 0.02 from a black body radiation locus on a chromaticity diagram. A range indicated by reference signs B and C around a black body radiation locus A is the range of the deviation of 0.02.

FIG. 9 shows a specific algorithm of image processing and light source color control of the arithmetic unit and the control unit.

In step S1, the arithmetic unit and the control unit select pixels used for processing from a photographed image. This is processing for, since processing time is long if pixels of the entire photographed image are processed, reducing the number of pixels to be processed, for example, creating grids (see FIG. 7) for, for example, every ten pixels in order to reduce time and selecting crossing points of the grids as pixels to be processed or selecting only an area in the center.

In step S2, the arithmetic unit and the control unit acquire R, G, and B gradation values of each of the pixels to be processed.

In step S3, the arithmetic unit and the control unit calculate, for each of the pixels, percentages of the R, G, and B gradation values. When the R, G, and B gradation values of one pixel are respectively represented as R, G, and B, the percentages of the R, G, and B gradation values are obtained by calculating R/(R+G+B), G/(R+G+B), and B/(R+G+B).

In step S4, if each percentage of R, G, and B of the pixel exceeds 30% all, the arithmetic unit and the control unit determine the pixel as an achromatic color.

In step S5, the arithmetic unit and the control unit calculate an average of the R, G, and B gradation values of the pixel determined as the achromatic color.

In step S6, if the average gradation value of R, G, and B of the achromatic Pixel is equal to or larger than 200 (when all gradations are 0 to 255) or equal to or larger than an input reference value, the arithmetic unit and the control unit determine that the pixel is a white pixel.

In step S7, if a percentage of white pixels with respect to all the pixels used for the processing is equal to or higher than a fixed percentage, the arithmetic unit and the control unit control light source colors by R, G, and B mixed light to be set within a range of a deviation of 0.02 from a black body radiation locus.

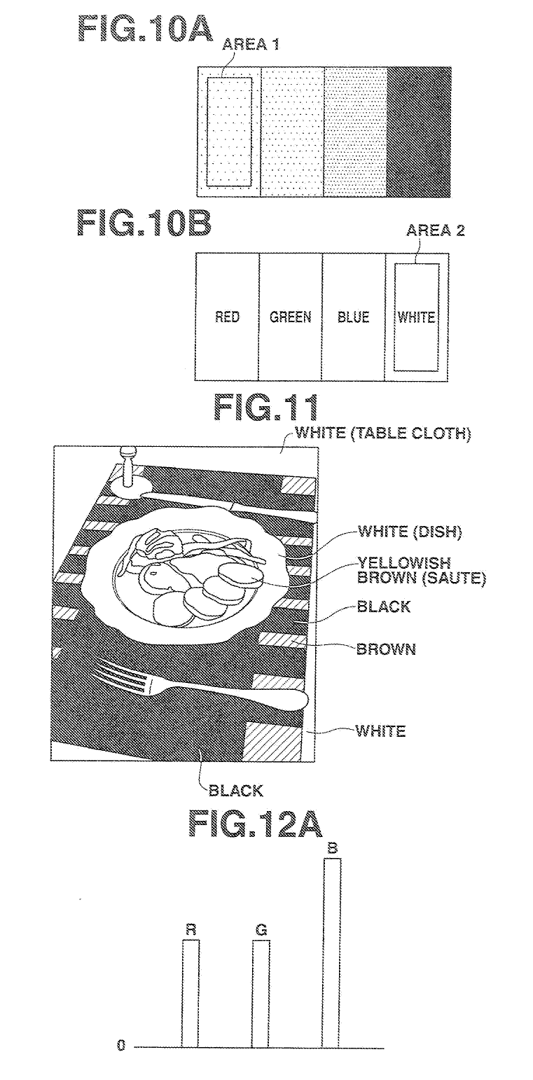

FIGS. 10A and 10B show images obtained by photographing a color chip of an achromatic color and a color chip of a chromatic color. FIG. 10A is a diagram showing the color chip of the achromatic color and FIG. 10B is a diagram showing the color chip of the chromatic color. In the achromatic color shown in FIG. 10A, the right end, is a black color having a lowest gradation and a gradation value increases stepwise from dark gray to bright gray further in the left direction.

An area 1 of the color chip in FIG. 10A is gray with reflectance of 40% and an average gradation value of R, G, and B in the area 1 is 195. On the other hand, in an area 2 of the color chip in FIG. 10B is a color chip of white and an average gradation value of R, G, and B in the area 2 is 230.

Therefore, in step S6 of the algorithm of the arithmetic unit, it is desirable to determine that pixels having an average gradation value equal to or higher than 200 are white.

However, depending on a photographing situation or a characteristic of an image sensor, although an object is actually a white object, an average gradation value of R, G, and B of the object may not be equal to or larger than 200. In such a case, a reference value for determining that a pixel is white may be corrected by inputting a numerical value of a reference gradation value or inputting a white area to calculate a gradation value.

For example, FIG. 11 shows an example in which food is photographed by an image sensor. In an image shown in FIG. 11, a dish and table portions are white and a percentage of a white area is about 20% with respect to the entire image.

Therefore, in step S7 of the algorithm of the arithmetic unit and the control unit, it is desirable to set the percentage of the white pixels with respect to all the pixels used for the processing to about 20%.

However, when an effect of making an object look bright is not obtained if the percentage is set to 20%, for example, when a white wall or utensil is present in a photographed image, input means that can input and change a numerical value may be provided.

As light sources, red, green, and blue lights may be added at light modulation ratios corresponding to RGB gradation values of an image with white light as a basis. In such a case, compared with light mixing of only single color light, it is easy to make a white object look white.

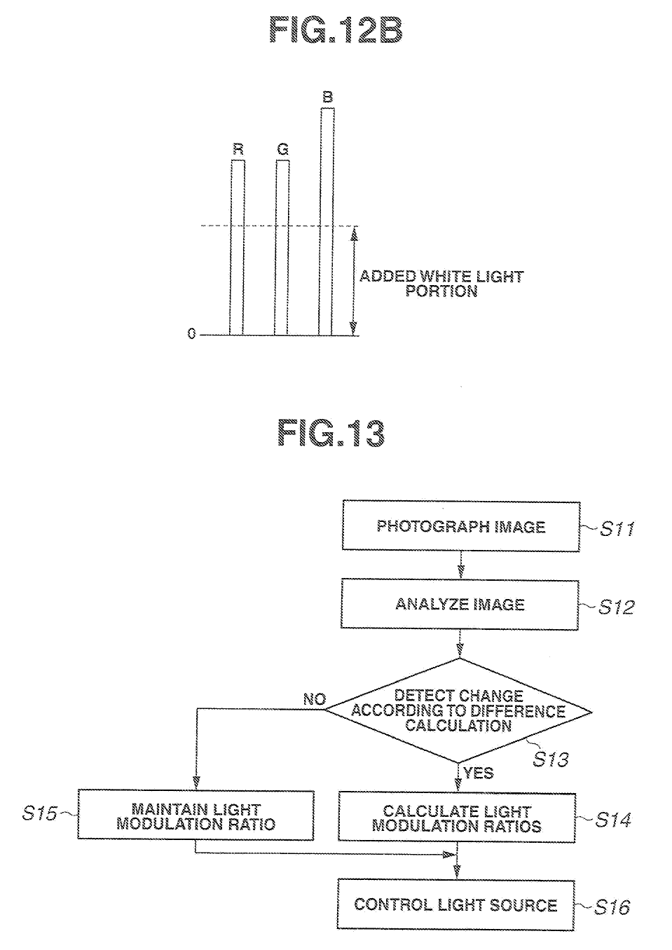

FIGS. 12A and 12B are diagrams for explaining an example of a method of making a white object look white in an illumination environment based on R, G, and B gradation values calculated for each of pixels. FIG. 12A is a diagram showing R, G, and B illumination lights having light modulation ratios corresponding to R, G, and B gradation values included in an object. FIG. 12B is a diagram showing R, G, and B illumination lights added with a white light component in an illumination state shown in FIG. 12A.

By detecting, using the image sensor 11, R, G, and B gradation values of an image obtained by photographing an illuminated object and turning on red, green and blue lights at light modulation ratios corresponding to the R, G, and B gradation values, it is possible to create an illumination environment in which colors of the object are highlighted.

In such an illumination environment, when there are a large number of specific color light components, if a white portion is present in the object, it looks as if the white portion is colored. Therefore, when a white object is present in the object in an area equal to, or larger than a fixed area, the red, green, and blue lights are mixed at the light modulation ratios corresponding to the R, G, and B gradation values. However, by controlling the light source unit 14 such that a chromaticity coordinate of a mixed light color is set within the range of a deviation of 0.02 from a black body radiation locus (i.e., generally in a range of white) in the process of the algorithm shown in FIG. 9, it is possible to make a white object look white.

First, in an illumination apparatus having a configuration same as that shown in FIG. 1, by averaging, concerning an entire image, R, G, B gradation values for each of pixels, percentages of R, G, and B components included in an object are calculated. A light mixing ratio of red, green, and blue lights are determined according to the percentages of the R, G, and B gradation values to control the light source unit 14. Consequently, the red, green, and blue lights are turned on at a gradation level shown in FIG. 12A and irradiated on the object from the light source unit 14 at light modulation ratios corresponding to R, G, and B gradation values of an image. In a state in which the illumination state is maintained, white light from separately-prepared RGB light sources, a ratio of R, G, and B color lights of which is 1:1:1, is irradiated on the object. In this way, as shown in. FIG. 12B, white light is increased to, so to speak, raise the R, G, and B color lights and the white light of the RGB light sources is increased until being set in the range of a deviation of 0.02 from a black body radiation locus in the process of the algorithm shown in FIG. 9. Consequently, it is possible to make a white object look conspicuous as white while illuminating the object highlighting color components of the object in a state in which a difference among the R, G, and B color components is maintained although the percentages of the R, G, and B color components are nearly equal.

It is explained that, besides the light source unit 14, the separately-prepared RGB light sources, the ratio of the R, G, and B color lights of which is 1:1:1, is used. However, by switching a mixed light amount of the R, G, and B color lights of the light source unit 14 from the state shown in FIG. 12A to the state shown in FIG. 12B using the same light source unit 14 without using the separately-prepared RGB light sources, it is also possible to make white look conspicuous while making the R, G, and B components of the object look conspicuous.

Therefore, by executing the algorithm shown in FIG. 9 to control the light source unit 14 from the illumination state shown in FIG. 12A, it is possible to increase the white light and make the white object conspicuous as white as shown in FIG. 12B.

In the second to fourth embodiments, the projection projector may be used as the light source unit.

The first to fourth embodiments explained, above are the illumination apparatus that photographs an illuminated object with the image sensor, detects and calculates positions and colors of the object, modulates plural color lights as appropriate such that plural colors included in the object shift to be bright and pleasant, and illuminates the object.

Incidentally, the first to fourth embodiments have problems explained below.

As explained above, in this embodiment, it is possible to repeat the process of photographing of an image of an object, analysis of colors of the image, determination of light modulation ratios of red, green, and blue lights, light mixing and irradiation and, photographing of an image, and when the object changes, change light colors according to the object, and make the colors of the object look bright.

However, when an object illuminated by illumination does not move, when the process of photographing of an image of an object, analysis of colors of the image, determination of light modulation ratios of red, green, and blue lights, light mixing and irradiation, and photographing of an image is repeated, for example, if there are a large number of red portions in the object, the light modulation ratio of the red light is increased to make the red portions of the object look bright.

When an image of the object is photographed again in the state, since red components are increased, the light modulation ratio of the red light further increases. When this is repeated, a percentage of the red light rapidly increases and the red light is irradiated to cause a problem in that the other colors become unattractive.

### Fifth Embodiment

The configuration of an illumination apparatus according to a fifth embodiment of the present invention is the same as that shown in FIG. 1.

The illumination apparatus according to the fifth embodiment includes: the light source unit 14 configured to be capable of irradiating at least red, green, and blue lights; the image sensor 11 configured to photograph an illuminated object; the arithmetic unit 12 including a first storing unit configured to store positions of pixels in an image photographed by the image sensor 11 and R, G, and B gradation values of the pixels, a second storing unit configured to calculate and store positions of pixels in an image photographed next and a difference value between R, G, and B gradation values of the pixels and the R, G, and B gradation value of the pixels at the time of the last photographing, and means configured to compare an nth (n is an integer equal to or larger than 1) difference value and an n+1 th difference value and detect movement of the illuminated object, the arithmetic unit 12 being configured to maintain, when there is no movement in the object according to a result of the comparison, a light modulation state at the, point; and the control unit 13 configured to control color lights of the light source unit 14 according to color components distributed on the object calculated by the arithmetic unit 12.

In this embodiment, images are continuously photographed and, when the object changes, red, green, and blue lights are irradiated at light modulation ratios suitable for the object, and, when the object does not change, light modulation ratios at the point are maintained.

The light source unit 14 includes light sources that mix lights of at least three colors of red, green, and blue and irradiate mixed light. Light obtained by mixing red, green, and blue on the basis of a white light source may be added. The white light source as the basis indicates light in a peripheral environment, i.e., the sunlight, or indicates a case in which an illumination light source as another background in a room is a white fluorescent lamp light source.

Means configured to detect movement of the object continuously photographs images of the object and compares differences of R, G, and B gradation values.

The operation in the fifth embodiment is explained in detail below.

FIG. 13 is a flowchart showing the operation of the illumination apparatus according to the fifth embodiment. Among steps S11 to S16, step S11 is the operation of the image sensor 11, steps S12 to S15 are the operation of the arithmetic unit 12, and step S16 is the operation of the control unit 13.

First, the illumination apparatus illuminates an object at a standard light mixing ratio of red, green, and blue lights. The image sensor 11 photographs an image of the object (step S11). A signal of the photographed image is sent to the arithmetic unit 12.

The, arithmetic unit 12 performs color analysis of the image (step S12) and then performs detection of a change in the object according to a difference calculation (step S13).

When a change in the object is detected, the arithmetic unit 12 calculates a light modulation ratio suitable for the object (step S14). The control unit 13 controls the light source unit 14 according to the calculated light modulation ratio to irradiate red, green, and blue lights (step S16). When a change in the object is not detected, the arithmetic unit 12 maintains the light modulation ratio at the point (step S15).

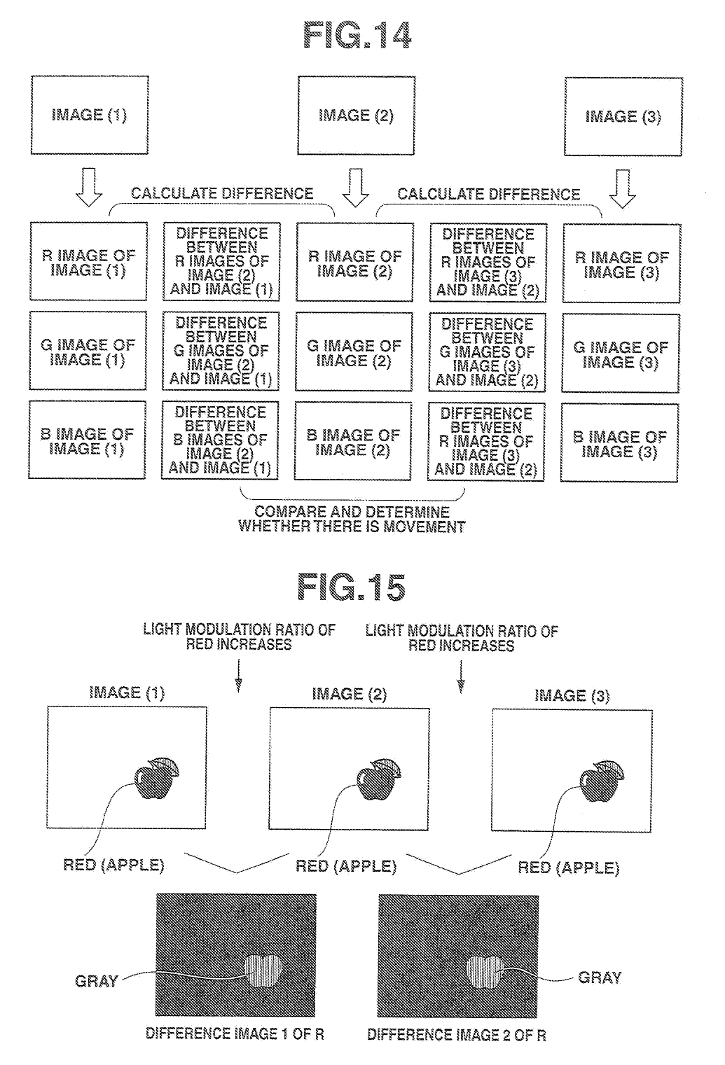

The detection of a change in the object according to the difference calculation in step S13 is operation for calculating a difference among three images (1), (2), and (3) photographed at a light modulation period (which gives changing timing for light modulation and coincides with a period for calculating and determining light modulation ratios (light mixing ratios) of colors) in every elapse of a fixed time as shown in FIG. 14 to thereby determine whether the object has moved and, when the object does not move, maintaining the light modulation ratios at that point. When it is determined that the object moves, the control unit 13 controls the light source unit 14 to irradiate light source lights on the object at the light modulation ratios at the point and make colors of the object look bright.

First, the object is illuminated by first illumination light (an initial value: color lights, a light mixing ratio of which is known in advance). An image of the object is photographed (an image (1)) and, as a result of analyzing colors of the image (1), light modulation ratios are determined and mixed light is irradiated.

Thereafter, when a fixed time (which may be, for example, time such as one second or several seconds) elapses and colors of an image (2) obtained by photographing the object again is analyzed, a difference between R, G, and B gradation values of pixels of the image (2) and the image (1) is calculated and positions of the pixels and the difference are stored. The positions of the pixels and the difference at this point are stored in the first storing unit in the arithmetic unit 12. Light modulation ratios are determined from a result obtained by analyzing colors of the image (2) and mixed light is irradiated from the light source unit 14.

Next, colors of an image (3) obtained by photographing the object are analyzed, a difference between R, G, and B gradation values of pixels of the image (3) and the image (2) is calculated, and positions of the pixels and the difference are stored in the second storing unit in the arithmetic unit 12. The difference between the image (2) and the image (1) and the difference between the image (3) and the image (2) are compared. The differences are differences between two images at a fixed time interval. Therefore, it can be said that the differences are difference images, respectively. The differences are compared by calculating a difference between the two difference images.

Therefore, when positions of the compared two difference images do not change, a difference value between the two difference images is nearly 0, it is determined that the difference images do not move, and light modulation ratios at the point are maintained.

When the positions of the compared two difference images change, a difference value between the two difference images has a certain value, it is determined that the difference images move, and light is irradiated on the object in a state of the light modulation ratios of the colors maintained when the difference images do not move. An image of the object is photographed by the image sensor 11 and, as a result of analyzing colors of the image, new light modulation ratios are determined, and mixed light according to the light modulation ratios is irradiated.

In this way, by calculating a difference between the difference images using the three images (1), (2), and (3), a change in image data due to a change in light modulation ratios can be deducted. Therefore, it is possible to detect only a change in the object. In other words, a change in the light modulation ratios, for example, a change in the image data due to an increase of a highlight amount of red light in every elapse of a fixed time can be deducted. Therefore, it is possible to detect only a change in the object, for example, a positional change of the object.

Rather than calculating and comparing a difference value concerning only specific one pixel, a difference is calculated and compared in every photographing concerning pixels in the same, positions among all pixels on a screen or pixels in a part of a range set in advance. A difference between first and second difference values for each of pixels is added up for all or a part of the pixels. If a total value of differences concerning all or a part of pixels of a photographed image is small compared with a threshold, it is determined that an object has not moved. Light modulation ratios at the time of the determination are kept (maintained). When the object moves, a shift occurs in positions of both difference images. Therefore, a difference between the difference values is calculated and, if the difference is larger than a threshold set in advance, it can be determined that the object has moved.

FIG. 15 shows an example of difference images. For example, a red (R) apple is used as an object. Images (1), (2), and (3) photographed according to the elapse of time are explained. A light modulation ratio of red light is increased by the arithmetic unit 12 between the image (1) and the image (2) and between the image (2) and the image (3). This is because, since control for making colors look bright explained above is performed, the red light increases in order of the images (1), (2), and (3) as time elapses. Therefore, to detect the movement of the object, a difference image 1 between the image (2) and the image (1) and a difference image 2 between the image (3) and the image (2) are compared and a difference value between the two difference images is calculated. If the difference value is smaller than the threshold set in advance, it is determined that the object has not moved. If the difference value is equal to or larger than the threshold, it is determined that the object has moved. When there is no movement in the object, the difference value between the two difference images is a value nearly 0. However, when there is movement in the object, since the position of one difference image of the two difference images shifts, when a difference value of the two difference images is calculated, the difference value has a certain value exceeding the threshold.

When an R difference image 1 between the image (1) and the image (2) and an R difference image 2 between the image (2) and the image (3) are compared, since the positions of the difference images are substantially the same, according to the magnitude of the difference between the R difference image 1 and the R difference image 2, the arithmetic unit 12 determines that there is no movement.

When the arithmetic unit 12 determines that there is no movement, the arithmetic unit 12 maintains light modulation ratios at the point of the determination. When the arithmetic unit 12 determines that there is movement, the control unit 13 modulates red, green, and blue lights at the light modulation ratios maintained when there is no movement.

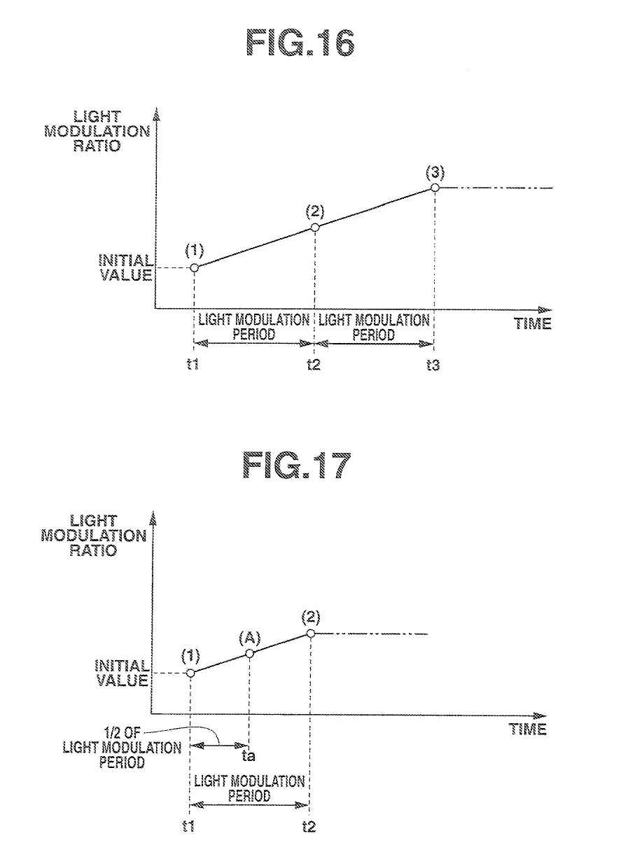

FIG. 16 is a graph for explaining the operation of the illumination apparatus according to the fifth embodiment. The image sensor 11 photographs three images (1), (2), and (3) of an object in a period of two light modulation periods. For example, a red (R) apple is explained as an object. At time t1, the illumination apparatus irradiates color lights on the object at light modulation ratios of initial values and photographs the object with the image sensor 11 to obtain the image (1) and determines a light mixing ratio of the color lights (which can also be regarded as a ratio of light modulation ratios of the colors) corresponding to color components included in the object from photographed R, G, and B gradation values. The control unit 13 starts light modulation control for the color light sources of the light source unit 14 with the light mixing ratio set as a target value. The light source unit 14 reaches a target, light modulation ratio (e.g., a light modulation ratio of red on the ordinate) corresponding to time t2 on the abscissa in the elapse of time to time t2. At time t2, the illumination apparatus performs photographing by the image sensor 11 to obtain the image (2). The illumination apparatus calculates a difference between the image (2) and the image (1) and stores the difference as a first difference image. Similarly, at time t3 after the elapse of a next light modulation period, the illumination apparatus performs photographing by the image sensor 11 to obtain the image (3), calculates a difference between the image (3) and the image (2), and stores the difference as a second difference image. The illumination apparatus calculates a difference between the second difference image and the first difference image. Determination on the movement of the object is performed by magnitude determination for a calculated value with respect to a threshold. As a result of the movement determination, if there is no movement, the illumination apparatus maintains a light modulation ratio of red at the time of the determination as indicated by an alternate long and two short dashes line shown in the figure.

Consequently, it is possible to prevent an inconvenience that the light modulation ratio of red gradually increases, for example, when the object has a large area of red. Even in a state in which the light modulation ratios at the time of the determination are maintained as a result of the determination that there is no movement of the object, thereafter, photographing of images is continuously performed at every fixed time. However, since the light modulation ratios are maintained as long as the object does not move, a difference concerning a next photographed image and a difference concerning the photographed image after next are also 0. Therefore, the light modulation ratios are maintained constant in a state in which the object does not move.

According to the fifth embodiment, by detecting R, G, and B gradation values of an image obtained by photographing an illuminated object using the image sensor and turning on red, green, and blue lights at light modulation ratios corresponding to the R, G, and B gradation values, it is possible to create an illumination environment in which colors of the object are highlighted. By photographing the object on a real time basis, it is possible to make the object look bright even if the object changes. When the object does not change, it is possible to prevent control for making the colors of the object look excessively bright.

### Sixth Embodiment

The configuration of an illumination apparatus according to a sixth embodiment of the present invention is the same as that shown in FIG. 1.

The sixth embodiment is an embodiment that should be referred to as a modification of the fifth embodiment.

The illumination apparatus according to the sixth embodiment includes: the light source unit 14 configured to be capable of irradiating at least red, green, and blue lights; the image sensor 11 configured to photograph an illuminated object; the arithmetic unit 12 including the first storing unit configured to store positions of pixels in an image photographed by the image sensor 11 and R, G, and B gradation values of the pixels, the second storing unit configured to calculate and store positions of pixels in an image photographed next and a difference value between R, G, and B gradation values of the pixels and the R, G, and. B gradation value of the pixels at the time of the last photographing, and the means configured to compare an nth (n is an integer equal to or larger than 1) difference value and an n+1th difference value and detect movement of the illuminated object, the arithmetic unit 12 configured to maintain, when there is no movement in the object according to a result of the comparison, a light modulation state at the point; and the control unit 13 configured to control color lights of the light source unit 14 according to color components distributed on the object calculated by the arithmetic unit 12.

FIG. 17 is a graph for explaining the operation of the illumination apparatus according to the sixth embodiment. The image sensor 11 photographs three images (1), (A), and (2) of an object in a period of one light modulation period. For example, a red (R) apple is explained as an object. At time t1, the illumination apparatus irradiates color lights on the object at light modulation ratios of initial values and photographs the object with the image sensor 11 to obtain the image (1) and determines a light mixing ratio of the color lights (which can also be regarded as a ratio of light modulation ratios of the colors) corresponding to color components included in the object from photographed R, G, and B gradation values. The control unit 13 starts light modulation control for the color light sources of the light source unit 14 with the light mixing ratio set as a target value. The light source unit 14 is controlled to reach a target light modulation ratio (e.g., a light modulation ratio of red on the ordinate) corresponding to time t2 on the abscissa in the elapse of time to time t2. The illumination apparatus performs photographing by the image sensor 11 at time to in the middle of light modulation before reaching time t2 (½ of the light modulation period) to obtain the photographed image (A). The illumination apparatus calculates a difference between the image (A) and the image (1) and stores the difference as a first difference image. Similarly, next, when the illumination apparatus reaches time t2 after the elapse of the remaining half period of the light modulation period, the illumination apparatus performs photographing by the image sensor 11 to acquire the image (2), calculates a difference between the image (2) and the image (A), and stores the difference as a second difference image. The illumination apparatus calculates a difference between the second difference image and the first difference image. Determination on the movement of the object is performed by magnitude determination for a calculated value with respect to a threshold.

As explained above, according to the sixth embodiment, since two difference images only have to be obtained, by photographing one image in the middle of the light modulation period in which light modulation is performed, i.e., if one more image is photographed while light modulation is performed, two difference images, i.e., a difference image between (A) and (1) and a difference image between (2) and (A) are obtained. If a difference between the two difference images is small, the illumination apparatus determines that there is no movement and keeps light modulation ratios at the point of (2) (indicated by an alternate long and two dashes line shown in the figure). Then, it is possible to halve time required for the movement determination compared with the fifth embodiment.

### Seventh Embodiment

The configuration of an illumination apparatus according to a seventh embodiment of the present invention is the same as that shown in FIG. 1.

The illumination apparatus according to the seventh embodiment includes: the light source unit 14 configured to be capable of irradiating at least red, green, and blue lights; the image sensor 11 configured to photograph an illuminated object; the arithmetic unit 12 including calculating means configured to calculate xy chromaticities from R, G, and B gradation values of pixels of an entire image or a part of the image photographed by the image sensor 11 and white determining means configured to distinguish whether each of the pixels is a white pixel on the basis of the calculated xy chromaticity of each of the pixels; and the control unit 13 configured to control, when a percentage of the number of pixels determined as the white pixels is equal to or higher than a predetermined percentage with respect to the number of pixels of the entire image or a part of the image, the light source unit 14 such that light source colors by R, G, and B mixed light are set within a range of a deviation of 0.02 from a black body radiation locus.

The seventh embodiment of the present invention is equivalent to another embodiment related to the fourth embodiment.

In this embodiment, for example, R, G, and B gradation values are linearly converted into a CIE1931xyz color space and R, G, and B gradation values of an entire image or at plural points of an area of an object desired to be made look bright are converted into tristimulus values X, Y, and Z to calculate xy chromaticities.

A relational expression between RGB values and xy values is as follows:

x=0.6R−0.28G−0.32B

y=0.2R−0.52G+0.31B

The xy chromaticities of pixels calculated from the R, G, and B gradation values are plotted on the chromaticity diagram shown. in FIG. 3 and points plotted in a range of white are determined as white pixels.

Operation after the determination of the white pixels is the same as that in the fourth embodiment of the present invention.

If a percentage of the number of white pixels with respect to the number of all pixels used for processing is equal to or higher than the predetermined percentage, this represents that an area occupied by the white pixels with respect to all the pixels to be processed is equal to or larger than a fixed area. Therefore, by controlling light source colors to be set within a range of white necessary as white on the chromaticity diagram of FIG. 8 (a range of a deviation of 0.02 from a black radiation locus), it is possible to make a white object look white.

FIG. 8 is the partial enlarged view of the CIE1960USC chromaticity diagram as explained in the fourth embodiment and represents the range of a deviation of 0.02 from a black body radiation locus on the chromaticity diagram. The range indicated by reference signs B and C around the black body radiation locus A is the range of a deviation of 0.02.

As explained above, the arithmetic unit 12 calculates, on the basis of a photographed image, a percentage of white in an object on which light is irradiated. When the percentage of white is equal to or higher than a fixed percentage, the control unit 13 performs light modulation such that light source colors mixed such that a white object looks white are set within a range in which the light source colors are recognized as white (specifically, the range of a deviation of 0.02 from a black body radiation locus).

This is on the basis of the description “can be represented as correlated color temperature with respect to a chromaticity coordinate of a light source present at a deviation within about 0.02 from a black body radiation locus on a CIE1960UCS chromaticity diagram” in JIS Z 8725. This means that a light source having a deviation within 0.02 can be regarded as white light.

According to the seventh embodiment, xy chromaticities of pixels calculated from R, G, and B gradation values are plotted on the chromaticity diagram and points plotted in a range of white are determined as white pixels. If a percentage of the number of white pixels is equal to or higher than the predetermined percentage, since an area of white of an object is equal to or larger than a fixed area. Therefore, by controlling light source colors to be set within a range of white necessary as white on the chromaticity diagram (the range of a deviation of 0.02 from a black eradiation locus), it is possible to make a white object look white.

### Eighth Embodiment

The configuration of an illumination apparatus according to an eighth embodiment of the present invention is the same as that shown in FIG. 1.

The illumination apparatus according to the eight embodiment includes: the light source unit 14 configured to be capable of irradiating at least red, green, and blue lights; the image sensor 11 including an XYZ filter approximated to a CIE1931 color matching function, the image sensor 11 being configured to photograph an illuminated object; the arithmetic unit 12 including measuring means configured to measure xy chromaticities of pixels of an entire image or a part of the image photographed by the image sensor 11 and white determining means configured to distinguish whether, each of the pixels is a white pixel on the basis of the measured xy chromaticity for each of the pixels; and the control unit 13 configured to control, when a percentage of the number of pixels determined as the white pixels is equal to or higher than a predetermined percentage with respect to the number of pixels of the entire image or a part of the image, the light source unit 14 such that light source colors by R, G, and B mixed light are set within a range of a deviation of 0.02 from a black body radiation locus.

The eighth embodiment of the present invention is equivalent to another embodiment related to the fourth embodiment.

In this embodiment, an image sensor includes an XYZ filter approximated to the CIE1931 color matching function. Xy chromaticities are calculated at plural points in an image by using the image sensor with the XYZ filter. The xy chromaticities at the points are plotted on the chromaticity diagram shown in FIG. 3 and points plotted in a range of white are determined as white pixels.

Operation after the determination of white pixels is the same as that in the fourth embodiment of the present invention.

If a percentage of the number of white pixels with respect to a total number of pixels used for processing is equal to or higher than the predetermined percentage, this represents that an area occupied by the white pixels with respect to all the processed pixels is equal to or larger than a fixed area. Therefore, by controlling the light source colors to be set within a range of white necessary as white on the chromaticity diagram of FIG. 8 (the range of a deviation of 0.02 from a black radiation locus), it is possible to make a white object look white.

According to the eight embodiment, the image sensor includes the XYZ filter approximated to the CIE1931 color matching function. Xy chromaticities are measured at plural points in an image by using the image sensor with the XYZ filter, the xy chromaticities at the points are plotted on the chromaticity diagram, and points plotted in a range of white are determined as white pixels. If a percentage of the number of white pixels is equal to or higher than the predetermined percentage, since an area of white of an object is equal to or larger than a fixed area. Therefore, by controlling light source colors to be set within a range of white necessary as white on the chromaticity diagram (the range of a deviation of 0.02 from a black radiation locus), it is possible to make a white object look white.

### Ninth Embodiment

The configuration of an illumination apparatus according to a ninth embodiment of the present invention is the same as that shown in FIG. 1.

The illumination apparatus according to the ninth embodiment includes: the light source unit 14 configured to be capable of irradiating at least red, green, and blue lights; the image sensor 11 configured to photograph an illuminated object; the arithmetic unit 12 including means configured to set an initial value of a light mixing ratio of light source colors of the light source unit 14, means configured to detect a change in the object over time on the basis of gradation values of pixels of an image photographed by the image sensor 11, and means configured to reset, when a change in the object is detected, the light mixing ratio to the initial value, the arithmetic unit 12 being configured to detect R, G, and B gradation values of pixels of an image photographed in a light mixing state at the initial value and calculate a light mixing ratio of the light source unit 14 according to the gradation values; and the control unit 13 configured to control color lights of the light source unit 14 according to the light mixing ratio calculated by the arithmetic unit 12.

This embodiment includes means that can set an initial value of a light mixing ratio in advance in light mixing of light sources for light colors of the light source unit 14. The light mixing ratio is set such that, for example, correlated color temperature is 3000 K (equivalent to warm white).

The image sensor 11 continuously photographs images. However, when a change in an object is detected, the control unit 13 modulates the light sources for the light colors of the light source unit 14 such that the light mixing ratio is reset to the initial value of the light mixing ratio. The change in the object indicates a change of the object moving as time elapses or being replaced. As the initial value of the light mixing ratio, for example, the light mixing ratio may be set in advance such that plural correlated color temperatures are obtained or may be set to obtain light colors such as warm white, natural white, and daylight and selected out of the colors.

Further, an image is photographed in an initial light mixing state, color information of the object is acquired from R, G, and B gradation values of pixels of the entire image or a part of the image in the initial light mixing state, a light mixing ratio is calculated, and the light sources for the light colors are modulated such that the light mixing ratio changes to a light mixing ratio suitable for the object. In other words, light modulation ratios for the light colors of the light source unit 14 are changed.

When the object changes, a light mixing state is always reset to the initial light mixing state and, thereafter, control of the light modulation ratio for the light colors is performed such that the light mixing state changes to a light mixing state suitable for the object.

When a change in the object is not detected, the light mixing ratio is maintained until a change in the object is detected next. In other words, the light modulation ratios for the light colors of the light source unit 14 are maintained.

As the detection of a change, for example, a difference between specific gradation values (e.g., G gradation values for looking at only brightness) of two images continuously photographed is calculated. According to whether a value of the difference is smaller than a threshold set in advance, it is determined whether there is no change in the object or there is a change in the object. Specifically, according to the elapse of time, a difference between gradation values of two images, i.e., the present image and the preceding image is calculated and a change in the object is detected according to whether a value of the difference exceeds the threshold set in advance. Alternatively, as a method of detecting a change in the object, a change in the object may be determined by comparing a difference value between two difference images from three images.

In this embodiment, when the object changes, R, G, and B gradation values of pixels are detected from an image photographed in the initial light mixing state and a light mixing ratio is calculated. The light source unit is controlled on the basis of the calculated light mixing ratio. When a change is not recognized, a light mixing ratio at the time when there is no change is maintained (in other words, the light mixing: ratio is fixed to a fixed value). The light mixing ratio is maintained until a change is recognized next.

According to the ninth embodiment, when an object changes, a light mixing state is always reset to the initial light mixing state and colors of the object are determined. Therefore, for example, when a large number of red components are included in an object, of a photographed image, if a light mixing state is reset to the initial state, it is possible to cancel a state in which red components are increased by mixed light illumination for making red look bright as in the first to fourth embodiments and it is possible to prevent control for making colors of the object excessively bright.

In the ninth embodiment, the initial light mixing state and a light mixing state suitable for an object alternately appear. It is likely that, when the object frequently changes, light colors frequently change to make a space unstable.

Therefore, control for preventing the light colors from suddenly changing such as control for providing limitation for preventing the light colors from changing in a fixed time interval, changing the light colors continuously and gently, or changing the light colors in time equal to or longer than one second may be performed. For example, in dinner at a restaurant, when food on a table changes according to the elapse of time, it is desirable to control colors of illumination lights to gently change.

### INDUSTRIAL APPLICABILITY

The present invention can be applied, in illuminating not only objects for shops dealing in food and the like and homes but also every object including those indoors and outdoors, to lighting the objects brightly and conspicuously.

The present invention is not limited to the embodiments explained above. Various changes, alterations, and the like are possible without departing from the spirit of the present invention.

This application is filed on the basis of the priority from Japanese Patent Application No. 2007-249993 filed in Japan on Sep. 26, 2007 and Japanese Patent Application No. 2007-309269 filed in Japan on Nov. 29, 2007 and the above disclosed content is cited in this specification and claims.

1-21. (canceled)

22. An illumination apparatus comprising:
a light source unit configured to be capable of irradiating at least red, green, and blue lights;
an image sensor configured to photograph an object illuminated by the light source unit;
an arithmetic unit configured to calculate color components distributed on the object on the basis of a photographed image; and
a control unit configured to control color lights of the light source unit according to the color components distributed on the object calculated by the arithmetic unit.

23. The illumination apparatus according to claim 22, wherein
the arithmetic unit calculates a distribution of colors corresponding to positions of portions of the object in the photographed image, and
the control unit controls the light source unit to generate the distribution of the colors corresponding to the positions on the object.

24. The illumination apparatus according to claim 22, wherein
the arithmetic unit detects colors of the object in the photographed image and determines a color included in the object most, and
the control unit controls the light source unit to create light of the color determined by the arithmetic unit.

25. The illumination apparatus according to claim 22, wherein the image sensor includes a filter approximated to an XYZ color matching function.

26. The illumination apparatus according to claim 22, wherein
the arithmetic unit detects R, G, and B gradation values of pixels in the photographed image and calculates a light mixing ratio in the light source unit according to the gradation values, and
the control unit controls the light source unit to reproduce the light mixing ratio determined by the arithmetic unit.

27. The illumination apparatus according to claim 22, further comprising means configured to select, in a photographed image, only a portion desired to be highlighted or a portion excluding a background as a target portion, wherein colors in a selected range can be highlighted.

28. The illumination apparatus according to claim 22, wherein the light source unit is a projection projector.

29. The illumination apparatus according to claim 26, wherein
the arithmetic unit includes:
calculating means configured to detect R, G, and B gradation values of pixels of the entire image or a part of the image photographed by the image sensor and calculate a percentage of the R, G, and B gradation values for each of the pixels;
achromatic color determining means configured to determine whether each of the pixels is a chromatic color or an achromatic color on the basis of the calculated percentage of the R, G, and B gradation values for each of the pixels; and
white determining means configured to distinguish between a white pixel and a gray pixel among the pixels determined as the achromatic color, and
the control unit controls, when a percentage of a number of pixels determined as the white pixels is equal to or higher than a predetermined percentage with respect to a number of pixels of the entire image or a part of the image, the light source unit such that light source colors by R, G, and B mixed light are set within a range of a deviation of 0.02 from a black body radiation locus.

30. The illumination apparatus according to claim 29, wherein
the achromatic color determining means determines that each of the pixels is the achromatic color when each percentage of the respective R, G, and B gradation values for each of the pixels in the calculating means is all equal to or higher than the predetermined percentage,
the white determining means calculates an average gradation value of the R, G, and B gradation values of the pixels determined as the achromatic color in the achromatic color determining means and, when the average gradation value is equal to or higher than a predetermined gradation value or equal to or higher than a standard value set in advance, determines that the pixels are white pixels, and
the control unit controls, when a percentage of the number of pixels determined as the white pixels is equal to or higher than the predetermined percentage with respect to the number of pixels of the entire image or a part of the image, the light source unit such that light source colors by R, G, and B mixed light are set within the range of a deviation of 0.02 from a black body radiation locus.

31. The illumination apparatus according to claim 30, wherein the predetermined percentage in the achromatic color determining means is 30%, the predetermined gradation value in the white determining means is 200 (when all gradations are 0 to 255), and the predetermined percentage in the control unit is 20%.

32. The illumination apparatus according to claim 30, wherein at least one of the predetermined percentage in the achromatic color determining means, the predetermined gradation value in the white determining means, and the predetermined percentage in the control unit can be variably set.

33. The illumination apparatus according to claim 26, wherein
the arithmetic unit includes:
a first storing unit configured to store positions of the pixels in the image photographed by the image sensor and the R, G, and B gradation values of the pixels;
a second storing unit configured to calculate and store positions of pixels in an image photographed next and a difference value between the R, G, and B gradation values of the pixels and the R, G, and B gradation values of the pixels at the time of the last photographing; and
means configured to compare an nth (n is an integer equal to or larger than 1) difference value and an n+1 th difference value and detect movement of the illuminated object, and
a light modulation state at that point is maintained when there is no movement in the object according to a result of the comparison.

34. The illumination apparatus according to claim 33, wherein the means configured to detect movement of the object calculates a difference between the n+1 th difference value and the nth difference value and determines the movement of the object according to whether the calculated difference is smaller than a threshold set in advance.

35. The illumination apparatus according to claim 33, wherein the photographing of an image by the image sensor is performed every time the light mixing ratio determined by the arithmetic unit is reproduced.

36. The illumination apparatus according to claim 33, wherein the photographing of an image by the image sensor is performed while the light mixing ratio determined by the arithmetic unit is reproduced and every time the light mixing ratio is reproduced.

37. The illumination apparatus according to claim 26, wherein
the arithmetic unit includes:
calculating means configured to calculate xy chromaticities from the R, G, and B gradation values of the pixels of the entire image or a part of the image photographed by the image sensor; and
white determining means configured to distinguish, on the basis of the calculated xy chromaticity for each of the pixels, whether each of the pixels is a white pixel, and
the control unit controls, when a percentage of the number of pixels determined as the white pixels is equal to or higher than a predetermined percentage with respect to the number of pixels of the entire image or a part of the image, the light source unit such that light source colors by R, G, and B mixed light are set within a range of a deviation of 0.02 from a black body radiation locus.

38. The illumination apparatus according to claim 26 wherein
the image sensor includes an XYZ filter approximated to a CIE1931 color matching function,
the arithmetic unit includes:
measuring means configured to measure xy chromaticities of the pixels of the entire image or a part of the image photographed by the image sensor; and
white determining means configured to distinguish whether each of the pixels is a white pixel on the basis of the measured xy chromaticity for each of the pixels, and the control unit controls, when a percentage of the number of pixels determined as the white pixels is equal to or higher than a predetermined percentage with respect to the number of pixels of the entire image or a part of the image, the light source unit such that light source colors by R, G, and B mixed light are set within a range of a deviation of 0.02 from a black body radiation locus.

39. The illumination apparatus according to claim 37, wherein the predetermined percentage is 20%.

40. The illumination apparatus according to claim 26 wherein
the arithmetic unit includes:
means configured to set an initial value of a light mixing ratio of light source colors of the light source unit;
means configured to detect a change in the object over time on the basis of gradation values of the pixels of the image photographed by the image sensor; and
means configured to reset the light mixing ratio to the initial value when a change in the object is detected, and
the arithmetic unit detects R, G, and B gradation values of pixels of an image photographed in a light mixing state at the initial value and calculates a light mixing ratio of the light source unit according to the gradation values.

41. The illumination apparatus according to claim 40, wherein the means configured to detect a change in the object over time calculates a difference between an n+1 th (n is an integer equal to or larger than 1) difference value and an nth difference value and detects a change in the object according to whether the difference is smaller than a threshold set in advance.
